(19) United States
(12) Patent Application Publication
(10) Pub. No.: US 2020/0189255 A1
(43) Pub. Date: Jun. 18, 2020

(54) THREE-DIMENSIONAL FABRIC COMPOSITE STRUCTURE AND PREPARATION METHOD THEREOF

(71) Applicant: TOMLONG TECHSTILE CORPORATION, Taichung City (TW)

(72) Inventor: Ming-Hsien Wu, Taichung City (TW)

(73) Assignee: TOMLONG TECHSTILE CORPORATION, Taichung City (TW)

(21) Appl. No.: 16/699,069

(22) Filed: Nov. 28, 2019

Related U.S. Application Data
(60) Provisional application No. 62/780,334, filed on Dec. 17, 2018.

(30) Foreign Application Priority Data
Jul. 31, 2019 (TW) 108127299

(51) Int. Cl. B32B 27/40; B32B 37/12; B32B 7/12; B32B 5/02; B32B 27/12; D03D 25/00; C09J 11/04; C09J 11/06; C09J 175/04

(52) U.S. Cl. CPC B32B 27/40; B32B 37/12; B32B 7/12; B32B 5/02; C09J 175/04; D03D 25/005; C09J 11/04; C09J 11/06; B32B 27/12

(57) ABSTRACT

A three-dimensional fabric composite structure and a preparation method thereof are provided. The three-dimensional fabric composite structure includes a three-dimensional fabric layer, first and second adhesive layers, and first and second bonding layers. The three-dimensional fabric layer has a first surface and a second surface opposite to each other. The first and second adhesive layers are respectively disposed on the first and second surfaces. The first and second bonding layers are respectively disposed on the first and second adhesive layers. The materials of the first and second bonding layers include polyether thermoplastic polyurethane (TPU) or polyester thermoplastic polyurethane.

### CROSS-REFERENCE TO RELATED APPLICATION

This application claims the priority benefit of U.S. provisional application Ser. No. 62/780,334, filed on Dec. 17, 2018, and Taiwan application serial no. 108127299, filed on Jul. 31, 2019. The entirety of each of the above-mentioned patent applications is hereby incorporated by reference herein and made a part of this specification.

### BACKGROUND OF THE INVENTION

### Field of the Invention

The invention relates to a three-dimensional fabric composite structure and a preparation method thereof, and in particular to a three-dimensional fabric composite structure subjected to functional processing and a preparation method thereof.

### Description of Related Art

In recent years, multifunctional fabrics have become popular products in the textile industry. Most of the conventional three-dimensional fabrics are breathable fabrics, which are limited in function. In addition, three-dimensional fabrics are different in construction from the general fabric in that except for the upper and lower fabrics, a yarn is provided in the middle to fix the distance between the upper and lower layers of fabric. Compared with the general two-layer three-dimensional fabric, the thickness of three-dimensional fabrics is greater, and a yarn for which a part thereof is not stretched is provided in the middle, resulting in poor surface flatness.

If a three-dimensional fabric is needed for operations in gas storage bags, such as gas inflatable cushions, life-saving protective textiles, inflatable motor boats, temporary docks, cushioning protective textiles, emergency ambulance docks, air beds, other inflatable protective materials, or building materials, etc., the double-sided fabric on both sides must be coated to fill the holes. However, the general coating method is mostly an immersion process. In addition to covering the surfaces of the upper and lower double-layer fabrics with fillers, the holes between the intermediate yarns are also covered by fillers, thereby reducing the performance of the inflation. Moreover, the holes in the surface of the fabric and the intermediate yarns are all covered by fillers, resulting in excessive weight. In addition, the gas storage products currently on the market are usually manufactured by using PVC molding, which has environmental disputes, heavy weight, and poor wear resistance.

Based on the above, the development of a three-dimensional fabric composite structure subjected to functional processing and a preparation method thereof that are more suitable for applications in gas storage bags is an important subject for current research.

### SUMMARY OF THE INVENTION

The invention provides a three-dimensional fabric composite structure subjected to functional processing and a preparation method thereof, and the three-dimensional fabric composite structure has antibacterial, conductive, heat conductive, flame resistance, surface scratch resistance, hardening, and foaming functions via the processing of a lighter and thinner coating.

The three-dimensional fabric composite structure of the invention includes a three-dimensional fabric layer, first and second adhesive layers, and first and second bonding layers. The three-dimensional fabric layer has a first surface and a second surface opposite to each other. The first and second adhesive layers are respectively disposed on the first and second surfaces. The first and second bonding layers are respectively disposed on the first and second adhesive layers. The materials of the first and second bonding layers include polyurethane such as polyether thermoplastic polyurethane (TPU) or polyester thermoplastic polyurethane.

In an embodiment of the invention, the three-dimensional fabric layer has a fiber fineness of 500 denier or more and a warp and weft weaving density of 60 strips/inch or more.

In an embodiment of the invention, the three-dimensional fabric layer has a fiber fineness of 250 denier or more and a warp and weft weaving density of 80 strips/inch or more.

In an embodiment of the invention, materials of the first adhesive layer, the second adhesive layer, the first bonding layer, and the second bonding layer further include an antibacterial agent, a conductive agent, a flame retardant, a surface scratch resist agent, a surface hardening agent, a UV absorbing agent, a colorant, or a foaming agent.

In an embodiment of the invention, materials of the first adhesive layer and the second adhesive layer include a thermosetting polyurethane resin.

In an embodiment of the invention, materials of the first adhesive layer and the second adhesive layer include a nano-scale additive, and the nano-scale additive includes silicate, calcium carbonate, talc, wollastonite, silicon dioxide, mica, or clay.

The invention provides a preparation method of a three-dimensional fabric composite structure used for preparing the three-dimensional fabric composite structure and includes the following steps. A three-dimensional fabric layer is provided, wherein the three-dimensional fabric layer has a first surface and a second surface opposite to each other. Next, an adhesive is coated on the first surface and the second surface of the three-dimensional fabric layer respectively and a baking process is performed to respectively form a first adhesive layer and a second adhesive layer on the first surface and the second surface. Next, a first bonding layer and a second bonding layer are formed on the first adhesive layer and the second adhesive layer, respectively.

In an embodiment of the invention, the adhesive is prepared by mixing a polyurethane resin, dimethylformamide, methyl ethyl ketone, and a bridging agent.

In an embodiment of the invention, the adhesive is formed by mixing a thermoplastic polyurethane resin and a bridging agent.

In an embodiment of the invention, a viscosity is adjusted to 5000 cps to 50000 cps using a solvent before the adhesive is coated on the three-dimensional fabric layer.

Based on the above, the invention provides a three-dimensional fabric composite structure subjected to functional processing and a preparation method thereof, wherein a multi-layered method is used to fill the holes on the surface of a three-dimensional fabric, and a functional composite layer conforming to different requirements is adhered to the three-dimensional fabric. Therefore, advantages of easy processing, lack of breathability during inflation, and good functionality are achieved, and an inflatable load operation may be readily completed upon completion of the finished product.

In order to make the aforementioned features and advantages of the disclosure more comprehensible, embodiments accompanied with FIGURES are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a three-dimensional fabric composite structure according to an embodiment of the invention.

### DESCRIPTION OF THE EMBODIMENTS

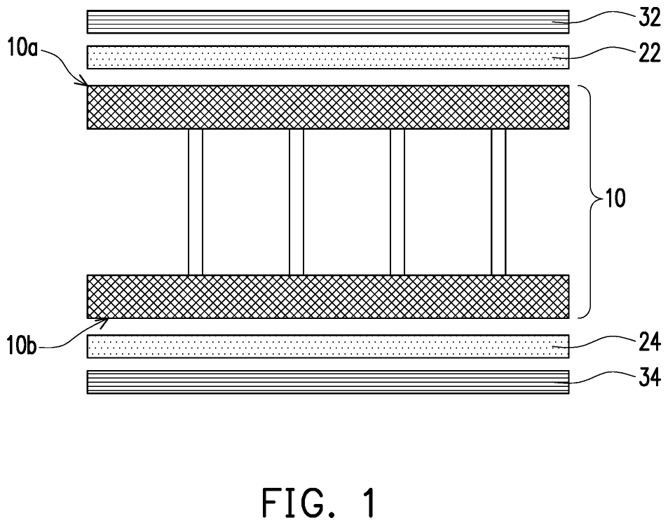

FIG. 1 is a schematic diagram of a three-dimensional fabric composite structure according to an embodiment of the invention. In the present specification, the size and proportion of layers and regions in the drawing may be exaggerated for clarity.

Referring to FIG. 1, a three-dimensional fabric composite structure includes a three-dimensional fabric layer 10, adhesive layers 22 and 24, and bonding layers 32 and 34. The three-dimensional fabric layer 10 has a first surface 10a and a second surface 10b opposite to each other. The adhesive layer 22 is disposed on the first surface 10a, and the adhesive layer 24 is disposed on the second surface 10b. The bonding layers 32 and 34 are disposed on the adhesive layers 22 and 24, respectively.

In the present embodiment, the materials of the bonding layers 32 and 34 are, for example, the same, and may include polyurethane such as polyether thermoplastic polyurethane (TPU) or polyester thermoplastic polyurethane. The materials of the adhesive layers 22 and 24 are, for example, the same, may include a thermosetting polyurethane resin, and may further include a nano-scale additive such as silicate, calcium carbonate, talc, wollastonite, silicon dioxide, mica, or clay, the amount of the nano-grade additive is, for example, 0.1% to 15%, and the nano-grade additive may fill the holes in the surface of the three-dimensional fabric to reduce the chance of air leakage. If the bonding layers 32 and 34 are directly disposed on the three-dimensional fabric layer 10, the adhesive ability may be worse and peeling readily occurs. Therefore, the adhesive layers 22 and 24 are additionally disposed between the bonding layers 32 and 34 and the three-dimensional fabric layer 10 to assist in adhesion. In addition, the invention may effectively alleviate issues such as environmental dispute, heavier weight, and poor wear resistance by using TPU in comparison to the conventional gas storage products manufactured by using PVC molding.

In the present embodiment, in order to provide the three-dimensional fabric composite structure with antibacterial, conductive, heat conductive, flame resistance, surface scratch resistance, hardening, and foaming functions, the materials of the adhesive layers 22 and 24 and the bonding layers 32 and 34 may further include an antibacterial agent, a conductive agent, a flame retardant, a surface scratch resistant agent, a surface hardening agent, a UV absorbing agent, a colorant, or a foaming agent. In more detail, the antibacterial agent is added in an amount of, for example, 0.001 phr to 5 phr to increase the antibacterial ability. The conductive agent is added in an amount of, for example, 0.01 phr to 50 phr to provide conductive function. The flame retardant is added in an amount of, for example, 1 phr to 50 phr to enhance flame resistance effect. The surface scratch resistance agent is added in an amount of, for example, 1 phr to 20 phr to improve surface scratch resistance. The surface hardening agent (inorganic substance) is added in an amount of, for example, 1 phr to 20 phr, which is effective for increasing surface hardness. The foaming agent is added in an amount of, for example, 1 phr to 20 phr, which may improve weight reduction, cushioning, sound insulation, and heat insulation effects. The UV absorbing agent is added in an amount of, for example, 0.01 phr to 15 phr to reduce the influence of sunlight or UV. The colorant is added in an amount of, for example, 0.01 phr to 20 phr to provide a change in color.

In the present embodiment, for the weaving density adjustment of the three-dimensional fabric layer 10, the fiber fineness of the three-dimensional fabric is 500 denier or more, and the warp and weft weaving density thereof is 60 strips/inch or more; the fiber fineness of the three-dimensional fabric is 250 denier or more, and the warp and weft weaving density thereof is 80 pieces/inch or more. As a result, the situation in which the adhesive layers 22 and 24 seep through the first surface 10a or the second surface 10b may be reduced.

The invention also provides a preparation method of a three-dimensional fabric composite structure used for preparing the three-dimensional fabric composite structure and includes the following steps. A three-dimensional fabric layer 10 is provided, wherein the three-dimensional fabric layer 10 has a first surface 10a and a second surface 10b opposite to each other. Next, an adhesive is coated on the first surface 10a and the second surface 10b of the three-dimensional fabric layer 10, respectively, and a baking process is performed to form the adhesive layers 22 and 24 on the first surface 10a and the second surface 10b, respectively. Next, the bonding layers 32 and 34 are formed on the adhesive layers 22 and 24, respectively. Each detail of the preparation method of the invention is described in detail below.

In the present embodiment, the adhesive may include a solvent-type single liquid adhesive or a double liquid adhesive, such as formed by mixing a polyurethane resin, dimethylformamide of 5 phr to 70 phr, methyl ethyl ketone of 1 phr to 50 phr, and a bridging agent of 0.1 phr to 40 phr; and may also include a solventless single liquid adhesive or a double liquid adhesive, such as formed by mixing a thermoplastic polyurethane resin and a bridging agent. The viscosity may be adjusted to about 5000 cps to about 50000 cps using a solvent before the adhesive is coated on the three-dimensional fabric layer 10. The solvent may include acetone, isobutanol, ethylene glycol ether, butanone, or ethyl acetate. Next, the adhesive is coated on the surface of the three-dimensional fabric layer 10 by a coating machine to a thickness of about 0.001 mm to 0.5 mm, and then placed in an oven at a temperature of, for example, 120° C. to 180° C.

In the present embodiment, the manner in which the bonding layers 32 and 34 are formed may include lamination processing or film processing, and the bonding layers 32 and 34 may be formed in a single layer one at a time, a single layer multiple times, or a plurality of layers single or multiple times. The lamination process may be processed by a lamination extrusion machine, the temperature is controlled, for example, at 160° C. to 250° C., and the thickness is, for example, 0.01 mm to 0.5 mm, and the polyether polyurethane or polyester polyurethane film is laminated on the three-dimensional fabric layer 10. After an embossing wheel, the pressure is controlled at about 5 kg/cm² to 50 kg/cm². The temperature of the film processing is controlled, for example, at 160° C. to 250° C., the thickness is, for example, 0.01 mm to 0.5 mm, the pressure is controlled at about 5 kg/cm² to 150 kg/cm², and the film is bonded to the three-dimensional fabric layer 10 by a hot pressing wheel.

Based on the above, the invention provides a three-dimensional fabric composite structure subjected to functional processing and a preparation method thereof. The three-dimensional fabric composite structure of the invention is a good air storage bag, and bag sealing processing may be subsequently completed with high frequency, ultrasound, hot pressing welding, or solvent processing, and may be used for gas inflatable cushions, life-saving protective textiles, inflatable motor boats, temporary docks, cushioning protective textiles, emergency ambulance docks, air beds, and other inflatable protective materials and building materials, etc. In the invention, the three-dimensional fabric composite structure has antibacterial, conductive, heat conductive, flame resistance, surface scratch resistance, hardening, and foaming functions via lighter and thinner coating processing, and may solve the issues of environmental dispute, heavier weight, and poor wear resistance of conventional gas storage products.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A three-dimensional fabric composite structure, comprising:
a three-dimensional fabric layer having a first surface and a second surface opposite to each other;
a first adhesive layer disposed on the first surface;
a second adhesive layer disposed on the second surface;
a first bonding layer disposed on the first adhesive layer; and
a second bonding layer disposed on the second adhesive layer,
wherein materials of the first bonding layer and the second bonding layer comprise polyurethane.

2. The three-dimensional fabric composite structure of claim 1, wherein a fiber fineness of the three-dimensional fabric layer is 500 denier or more, and a warp and weft weaving density thereof is 60 strips/inch or more.

3. The three-dimensional fabric composite structure of claim 1, wherein a fiber fineness of the three-dimensional fabric layer is 250 denier or more, and a warp and weft weaving density thereof is 80 strips/inch or more.

4. The three-dimensional fabric composite structure of claim 1, wherein materials of the first adhesive layer, the second adhesive layer, the first bonding layer, and the second bonding layer further comprise an antibacterial agent, a conductive agent, a flame retardant, a surface scratch resist agent, a surface hardening agent, a UV absorbing agent, a colorant, or a foaming agent.

5. The three-dimensional fabric composite structure of claim 1, wherein materials of the first adhesive layer and the second adhesive layer comprise a thermosetting polyurethane resin.

6. The three-dimensional fabric composite structure of claim 1, wherein materials of the first adhesive layer and the second adhesive layer comprise a nano-scale additive, and the nano-scale additive comprises silicate, calcium carbonate, talc, wollastonite, silicon dioxide, mica, or clay.

7. A preparation method of a three-dimensional fabric composite structure, for preparing the three-dimensional fabric composite structure of claim 1, comprising:
providing a three-dimensional fabric layer, wherein the three-dimensional fabric layer has a first surface and a second surface opposite to each other;
coating an adhesive on the first surface and the second surface of the three-dimensional fabric layer respectively and performing a baking process to respectively form a first adhesive layer and a second adhesive layer on the first surface and the second surface; and
forming a first bonding layer and a second bonding layer on the first adhesive layer and the second adhesive layer, respectively.

8. The preparation method of the three-dimensional fabric composite structure of claim 7, wherein the adhesive is formed by mixing a polyurethane resin, dimethylformamide, methyl ethyl ketone, and a bridging agent.

9. The preparation method of the three-dimensional fabric composite structure of claim 7, wherein the adhesive is formed by mixing a thermoplastic polyurethane resin and a bridging agent.

10. The preparation method of the three-dimensional fabric composite structure of claim 7, wherein a viscosity is adjusted to 5000 cps to 50000 cps using a solvent before the adhesive is coated on the three-dimensional fabric layer.
